(19) United States
(12) Patent Application Publication
(10) Pub. No.: US 2026/0251488 A1
(43) Pub. Date: Aug. 27, 2026

(54) CONTAINER WITH INCLUDED MEASURING

(71) Applicant: SEALER LIFE, LLC, Fort Myers, FL (US)

(72) Inventor: GREGORY E. TATUM, Sarasota, FL (US)

(21) Appl. No.: 19/064,075

(22) Filed: Feb. 26, 2025

(51) Int. Cl. G01F 19/00; B65D 25/28; B65D 47/12

(52) U.S. Cl. CPC G01F 19/00; B65D 25/2808; B65D 25/282; B65D 47/122; B65D 2203/04

(57) ABSTRACT

A container with included measuring for retaining and pouring a fluid includes a body having a side wall that terminates at a side wall top edge, a bottom wall connected with the side wall at a lower end, and open upper end, which together define an inner chamber. There is preferably a circular lid connectable with the body and having a top surface, bottom surface and outer edge. The circular lid contains a through opening through which liquid can flow. Measuring indicia is arranged on an outer surface of the body side wall, including a plurality of spaced planar guides. At least a portion of the guides have one of a generally parabolic and elliptic shape with rates of change of each planar guide progressively increasing from an upper end of the container toward a lower end. An amount of fluid in the container is measured by at least one of the plurality of spaced planar guides when the container is in an angled position.

### BACKGROUND

The present disclosure relates to a container for retaining and pouring a fluid, and more particularly to such a container with measuring indicia included thereon.

Containers with measuring indicia are known in the art. Such containers, also known as integrated buckets, typically include vertical measuring indicia on a clear or translucent container body such that any content within the container can be measured when the container is placed on a flat surface. This is similar to measuring indicia present on measuring cups, jugs, pitchers, or the like.

While these containers are beneficial in that they provide an easy method for measuring fluid within the container when the container is in its resting position, they do not provide forms of measuring when the container is in other positions. This is a drawback for containers, such as integrated buckets, that are used for pouring heavy fluids and require the container be placed in its down, resting position every time a measurement is needed.

There is thus a need for a container with measuring indicia that can provide measurements of a liquid within the container when the container is in positions other than its down, resting position.

### SUMMARY OF THE INVENTION

Accordingly, it is an object of the present disclosure to provide a cylindrical container with included measuring for retaining and pouring a fluid. The container includes a cylindrical body having a side wall that terminates at a side wall top edge, a bottom wall connected with the side wall at a lower end, and an open upper end, which together define an inner chamber. Preferably, there is a circular lid connectable with the body and having a top surface, bottom surface and outer edge. The circular lid contains a through opening through which fluid can flow. Measuring indicia is arranged on an outer surface of the body side wall, including a plurality of guides. At least a portion of the guides have one of a generally parabolic and elliptic shape with a rate of change of each guide progressively increasing from an upper end of the container toward a lower end. When a fluid is present in the chamber and the body is tilted to be arranged at an angle relative to a container resting position to pour the fluid out of the container, the amount of fluid in the container is measured by at least one of the guides. Preferably, the lid includes a threaded spout arranged at the container opening.

In another embodiment, the measuring indicia further includes pairs of spaced guides. Each guide of a pair of spaced guides is arranged opposite the other on the body side wall to represent a side of one of a generally parabolic or elliptic curve wherein at least one vertex is not present.

In yet another embodiment, the measuring indicia includes a first and second set of spaced planar guides. The first set includes a plurality of planar guides that correspond with a point on the side wall upper edge and the second set includes a plurality of planar guides that correspond with the lid through opening.

In a further embodiment, the container comprises a handle connected with an upper portion of the body side wall and a collar arranged at an upper portion of the body side wall. The collar has a diameter that is greater than a diameter of the body.

In an even further embodiment, the lid has a side wall that extends from the lid outer edge downward and perpendicular to the lid bottom surface. Preferably, the lid side wall contains a plurality of spaced notches.

It is further an object of the present disclosure to provide a method for measuring fluid in a container having measuring indicia as described above. The steps of the method include transferring fluid into the inner chamber to a desired level, lifting and tilting the container to pour the fluid out of the container, maintaining the tilt of the container so that the fluid in the chamber remains at an angle relative to a bottom wall of the container, measuring the remaining fluid in the chamber via measuring indicia that is arranged on a side wall of the container at an angle relative to the bottom wall and substantially equal to the angle of the fluid in the tilted container, and one of pouring more fluid out of the container or setting the container down.

In a separate embodiment, the lid is connected with the container and the fluid is poured through the lid opening.

### BRIEF DESCRIPTION OF THE DRAWINGS

Other objects and advantages of the invention will become apparent from a study of the following specification when viewed in the light of the accompanying drawing, in which:

FIG. 1 is a perspective view of a container with included measuring according to the present disclosure;

FIGS. 2 and 3 are top and bottom perspective views of a second container with included measuring with and without a lid, respectively, according to the present disclosure;

FIGS. 4 and 5 are side views of the container of FIG. 2 with fluid flowing therefrom;

FIG. 6-9 are perspective views of the container of FIG. 2;

FIG. 10-13 are front, rear, right side, and left side views, respectively, of the container of FIG. 2;

FIG. 14 is a top view of the container of FIG. 2;

FIGS. 15 and 16 are front and rear views of the container of FIG. 3;

FIG. 17 is a perspective view of the container of FIG. 3;

FIGS. 18 and 19 are top and bottom views of the container of FIG. 3;

FIGS. 20 and 21 are cross-sectional views of the containers of FIGS. 2 and 3, respectively; and

FIG. 22 is a planar representation of a portion of measuring indicia for a container according to the present disclosure.

### DETAILED DESCRIPTION

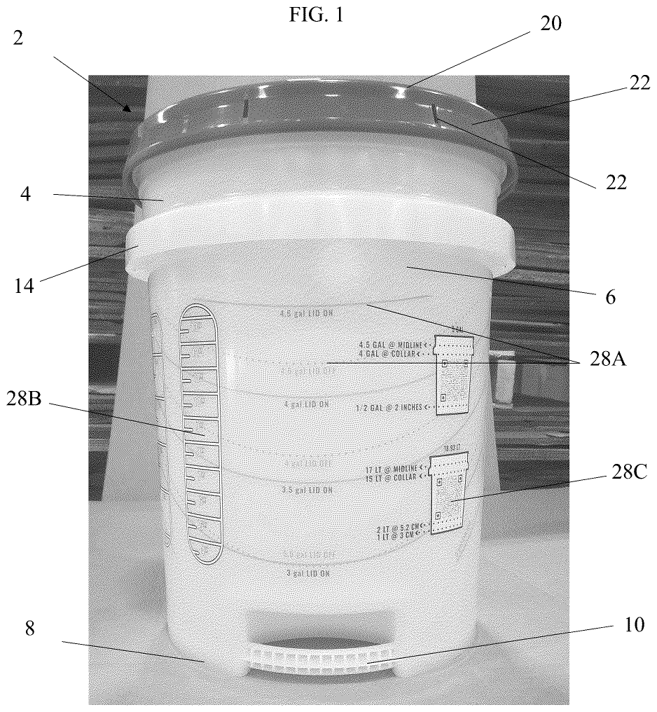

Referring first to FIG. 1, there is a cylindrical container 2 with measuring thereon for retaining and pouring a fluid. In certain embodiments, the container is a transparent or translucent container the size of or similar to that of a five-gallon bucket, which can be handled by an individual person or pair of individuals without the need for an additional, external force. However, it will be understood by those with skill in the art that the size of the container can vary without deviating from the spirit and scope of the invention.

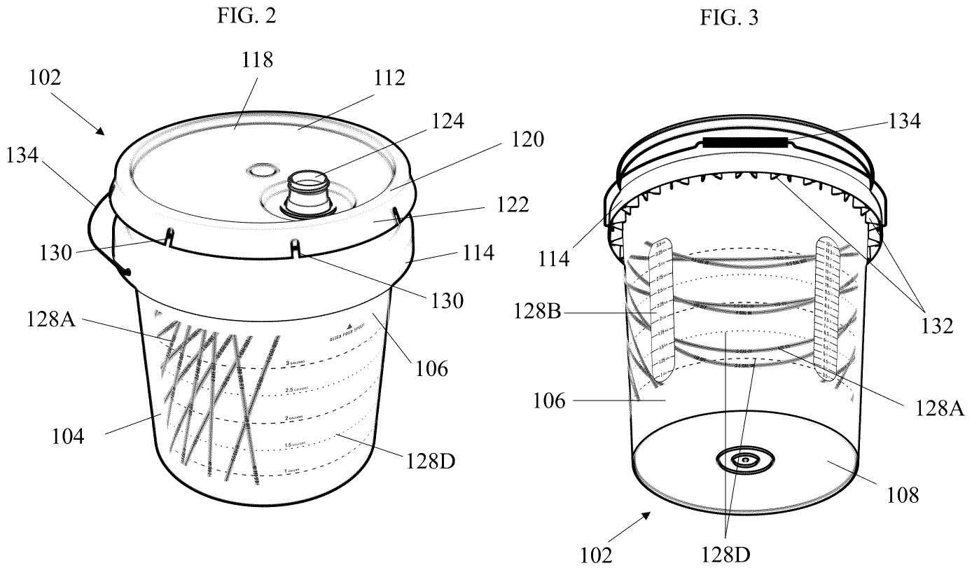

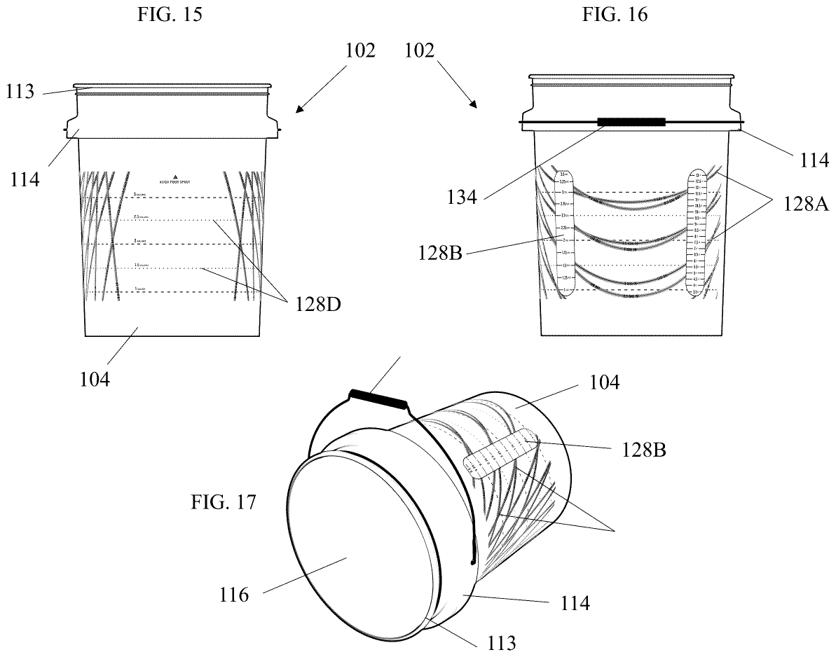

The container includes a cylindrical body 4 that has a circular side wall 6, a bottom wall 8 connected with a lower end of the side wall, and a handle 10 arranged at an interface of the side wall and bottom wall. A lid 12 is connected with an upper end of the side wall and a collar 14 is located at an upper portion of the side wall. The side wall and bottom wall define an inner chamber (shown in FIG. 17). The lid has a circular configuration and a top surface 18, bottom surface (not shown), outer edge 20, a side wall 22 extending downward from the outer edge, and a spout with opening (see FIG. 2). The lid side wall provides a press-fit connection between the lid and container upper end. The lid further contains a plurality of spaced elongated openings 26.

There is measuring indicia 28 arranged on an outer surface of the body side wall 6. This measuring indicia can take many forms. As shown in FIG. 1, the measuring indicia includes a plurality of spaced planar guides with measurement indicators 28A, two vertically arranged scales 28B and two container schematics 28C with measuring indicators. The spaced planar guides have generally parabolic shapes and include two sets, for measuring with and without the lid. The rate of change of each planar curve progressively increases from an upper end of the container toward a lower end.

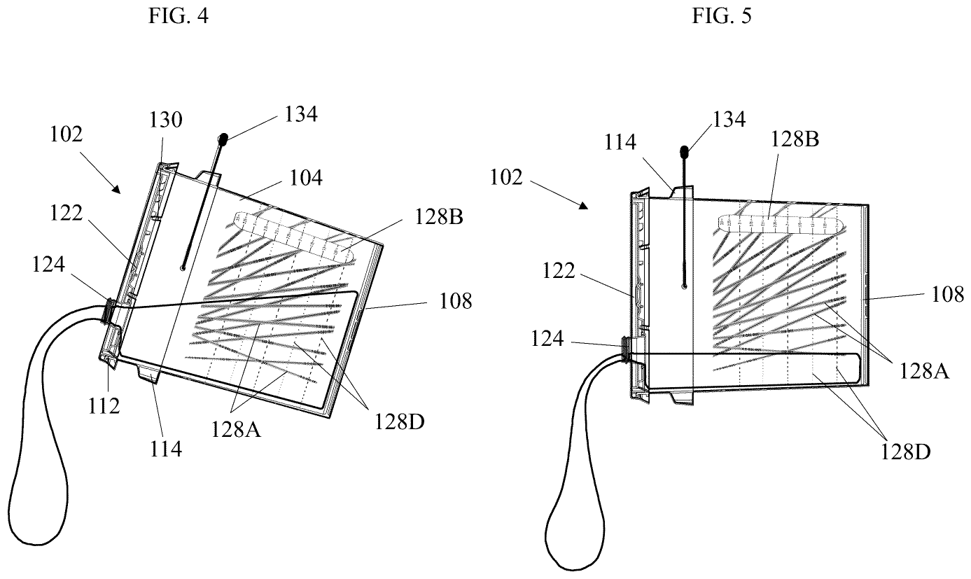

FIGS. 1, 4 and 5 demonstrate how the measuring indicia is used with a container having the lid connected therewith. First, fluid can be put into the container when the container is in its resting position, which is shown in FIG. 1. The vertical measuring indicia is used to determine the amount of fluid in the container when in the resting position. Once fluid is present in the chamber of the container and the body is lifted and tilted to be arranged at an angle relative to the container resting position, fluid flows through the spout, as shown in FIGS. 4 and 5. As fluid flows out of the container, resulting in the amount of fluid in the container decreasing, the spaced planar guides indicate the remaining amount of fluid in the container without the need for pivoting the container back to its resting position. This is particularly beneficial when an individual is handling a container with a heavy fluid. As shown in FIG. 1, there are “LID ON” and “LID OFF” guides to account for different positions of the fluid when the lid is on or off, respectively. For the fluid flow shown in FIGS. 4 and 5, the LID ON lines would be used to determine the remaining amount of fluid in the container while in the tilted position.

It will be understood by those with skill in the art that fluid could be added at the time of using the container or prior to doing so. For example, in one embodiment, ingredients could be added and the container and lid sealed thereon for transport to another location. This is beneficial when ingredients must be pre-mixed and/or they need to be transported in an integrated bucket. In a separate example, an empty container is used such that ingredients can be added to the container and measured prior to lifting and pouring. This is beneficial for instances where ingredients must be prepared at or close to the time of dispensing the fluid out of the container, or if the container is to be reused.

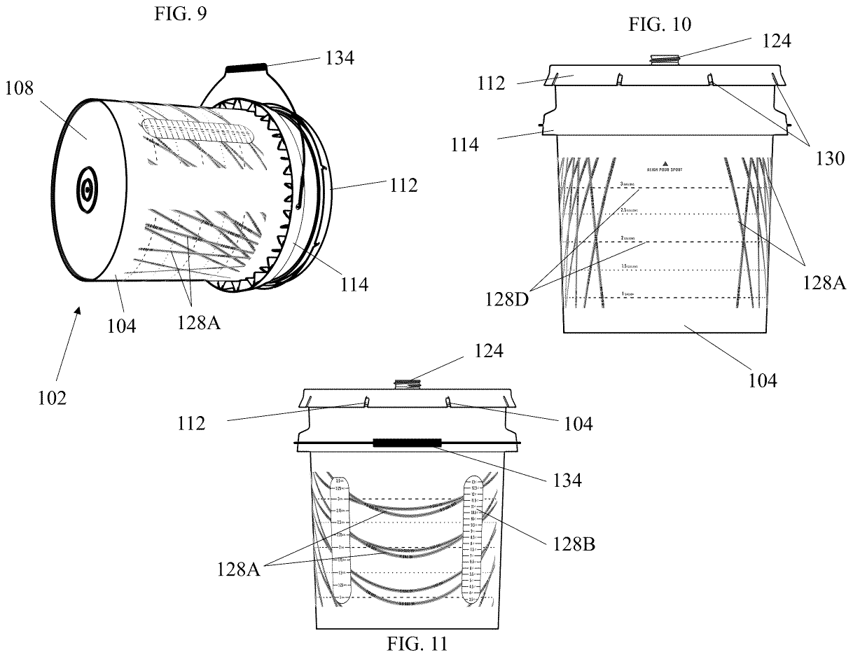

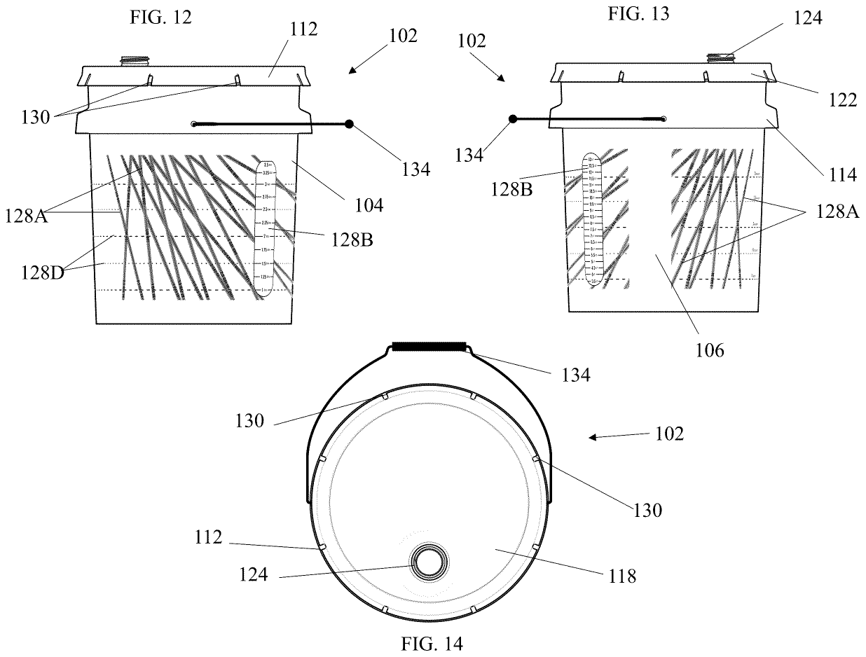

Referring now to FIGS. 2, 3 and 6-17, there is a container 102 similar to the one shown in FIG. 1. Again, there is a cylindrical body 104 that has a circular side wall 106, a bottom wall 108 connected with a lower end of the side wall, a lid 112 connected with an upper end 113 of the side wall, and a collar 114. The side wall and bottom wall define an inner chamber 116. The lid includes a top surface 118, bottom surface (not shown), outer edge 120, side wall 122 and spout 124. The side wall extends downwardly from the outer edge and contains a plurality of spaced notches 130 configured for connecting the lid with an upper edge of the container body at a midline. As shown in FIGS. 10 and 11, the spout is threaded for receiving a corresponding cap (not shown).

The collar 114 located at an upper portion of the side wall provides structural support to the container, along with providing a mechanism for lifting and carrying the container. The collar includes a plurality of vertical walls 132 connected with an inner surface of the collar and an outer surface of the container body, arranged at an angle therebetween.

This container, however, does not include a lower end handle that is integral with the container body, as is the case with the container of FIG. 1, but rather includes a pivotable handle 134 connected with an upper portion of the container body.

As is shown in FIGS. 3 and 11, the measuring indicia 128 of this container is similar to the measuring indicia 28 shown in FIG. 1 in that the rear of the container includes a plurality of spaced planar guides with measurement indicators 128A and two vertically arranged scales with measuring indicators 128B. The spaced planar guides have generally parabolic shapes and include two sets, for measuring with and without the lid. The rate of change of each planar curve progressively increases from an upper end of the container toward a lower end. This embodiment further includes a plurality of circular broken lines 128D arranged on the body side wall 106

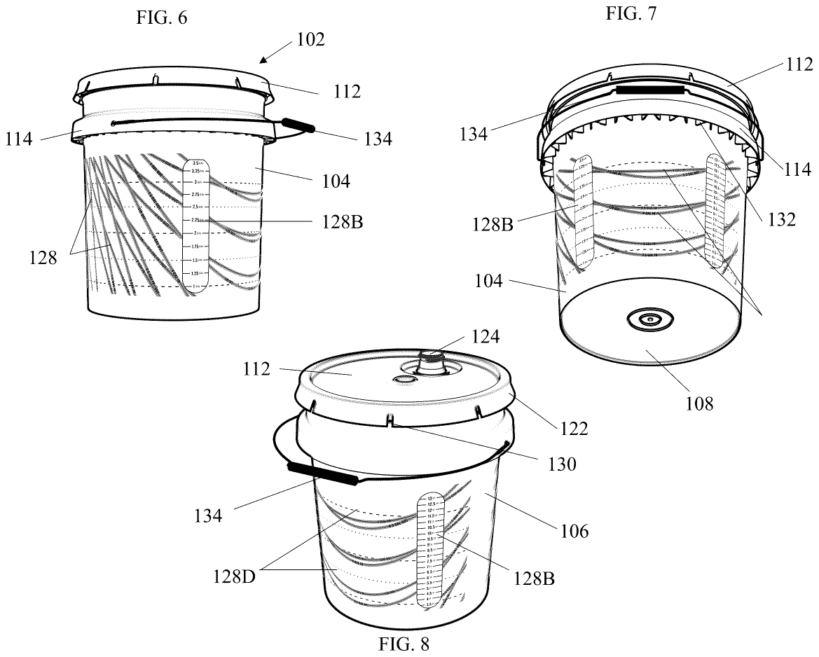

As is shown in FIGS. 6, 8 and 9, the plurality of spaced planar guides 128A extend along sides of the body 104 to define generally elliptic guides, though each ellipse is not present in its entirety. The elliptic guides are arranged such that each ellipse extends to an imaginary vertex located at one of a top edge point of the body 136 or the lid spout 124, the former for LID OFF guides and the latter for LID ON guides. Some ellipses include only sides of the ellipse, with imaginary portions extending to the top edge/spout at one end and to the container bottom at another.

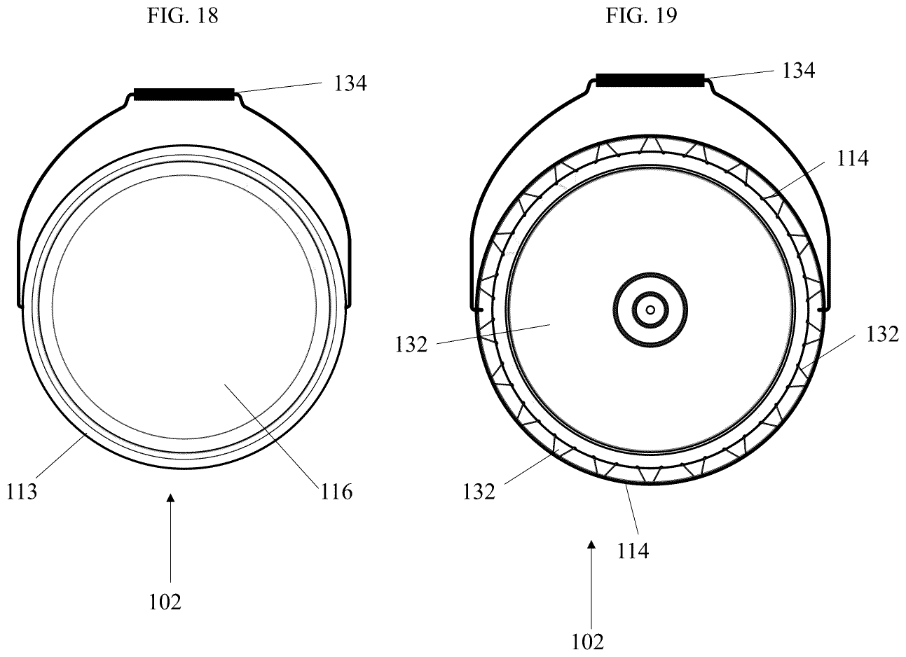

FIGS. 18 and 19 show top and bottom views, respectively of the container 102 without the lid. The collar 114 structural walls are shown in FIG. 19.

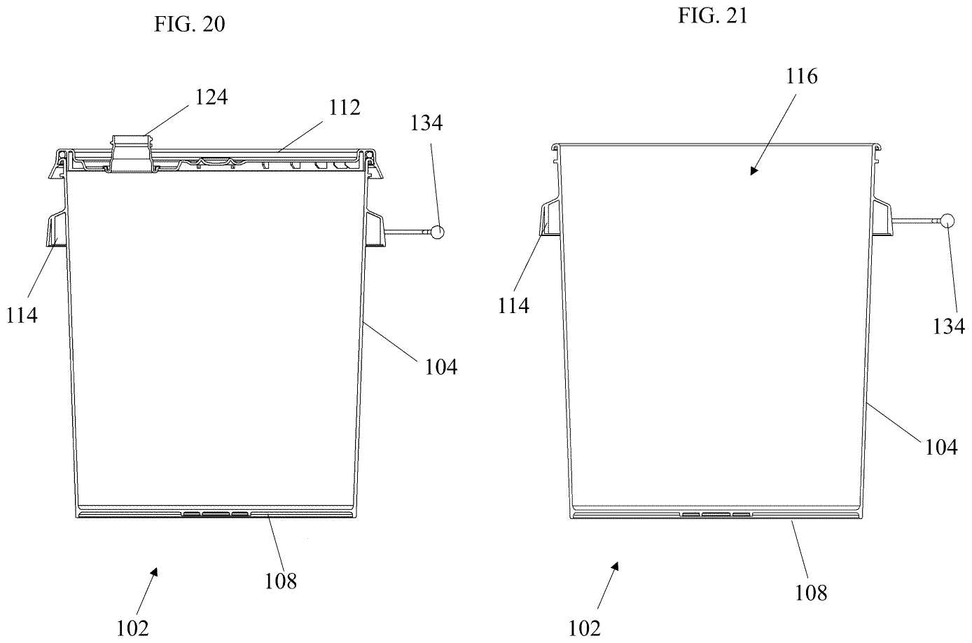

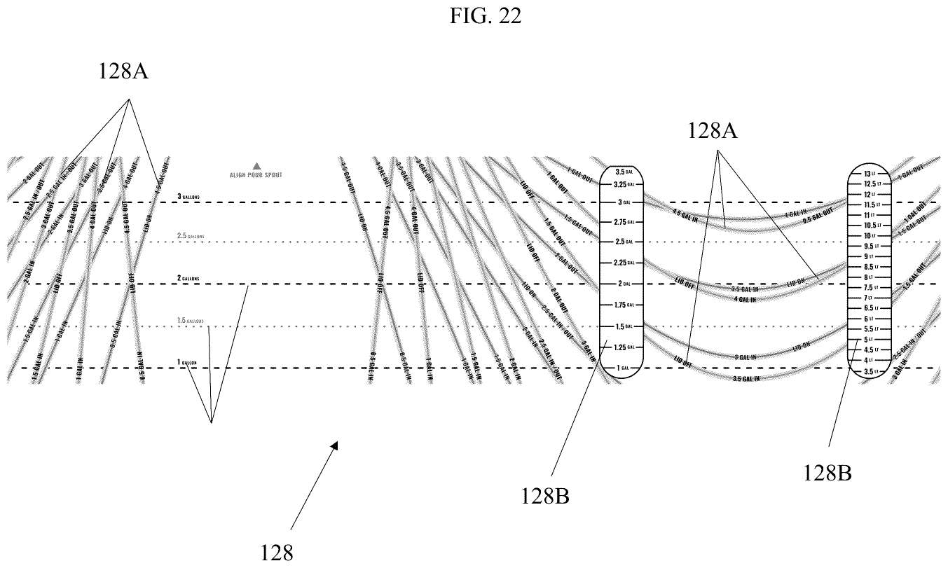

FIGS. 20 and 21 show cross-sectional views of the container 102 with and without the lid 112, respectively.

FIG. 22 is a planar view of a portion of the measuring indicia 128 with curved and vertical measurements.

While the preferred forms and embodiments of the invention have been illustrated and described, it will be apparent to those of ordinary skill in the art that various changes and modifications may be made without deviating from the inventive concepts set forth above.

What is claimed is:

1. A container for retaining and pouring a fluid, comprising:
a. a body having a side wall terminating at an upper edge, a bottom wall connected with a lower end of the side wall, and an open upper end defining an inner chamber; and
b. measuring indicia arranged on a surface of the body side wall, the measuring indicia including at least one guide arranged at an angle relative to the body bottom wall, at least a portion of the guide having one of a generally parabolic and elliptic shape, whereby when a fluid is present within the chamber and the body is tilted to be arranged at an angle relative to a container resting position to pour the fluid out of the container, the amount of fluid in the container is measured by the least one guide.

2. A container as defined in claim 1, wherein the at least one guide includes a plurality of spaced guides arranged at varying angles relative to the body bottom wall, a rate of change of each guide progressively increasing from an upper end of the container toward a lower end.

3. The container as defined in claim 2, the container body having a cylindrical configuration, wherein the measuring indicia further includes pairs of spaced guides, each guide of a pair of spaced guides being arranged opposite the other on the body side wall and representing a side of one of a generally parabolic and elliptic shape wherein a vertex is not present.

4. The container as defined in claim 3, and further comprising a circular lid connectable with the body and having a top surface, bottom surface and outer edge, the circular lid containing a through opening.

5. The container as defined in claim 4, wherein the measuring indicia includes a first and second set of spaced guides, the first set including a plurality of guides that correspond with a point on the side wall upper edge and the second set including a plurality of guides that correspond with the lid through opening, a lid through opening alignment marker being arranged on the body side wall opposite a vertex of one of the spaced guides.

6. The container as defined in claim 5, and further comprising a handle being one of an integrated, stationary handle and a handle connectable with an upper portion of the body side wall.

7. The container as defined in claim 6, and further comprising a collar arranged at an upper portion of the body side wall, the collar having a diameter that is greater than a diameter of the body.

8. The container as defined in claim 7, the lid further including a spout extending outward from an edge of the lid through opening.

9. The container as defined in claim 8, the spout having a threaded outer surface.

10. The container as defined in claim 9, the lid further having a side wall extending from the outer edge perpendicular to the bottom surface, the lid side wall containing a plurality of spaced notches.

11. The container as defined in claim 10, wherein the measuring indicia further includes at least one longitudinal measuring scale arranged on the body side wall.

12. The container as defined in claim 11, wherein the measuring indicia further includes a plurality of circular guides arranged parallel to the body bottom wall.

13. A method for measuring fluid in a container having measuring indicia arranged thereon, comprising the steps of:
a. transferring fluid into an inner chamber of the container to a desired level;
b. lifting and tilting the container to pour the fluid out of the container;
c. maintaining the tilt of the container so that the fluid in the chamber remains at an angle relative to a bottom wall of the container;
d. measuring the remaining fluid in the chamber via measuring indicia that is arranged on a side wall of the container at an angle relative to the bottom wall and substantially equal to the angle of the fluid in the tilted container; and
e. one of pouring more fluid out of the container or setting the container down.

14. A method for measuring fluid in a container as defined in claim 13, wherein the container is one of a transparent and translucent container.

15. A method for measuring fluid in a container including a sealable lid having a through opening, comprising the steps of:
a. measuring fluid in an inner chamber of the container;
b. removing a cap on the through opening if one is present;
c. lifting and tilting the container to pour fluid through the opening;
d. maintaining the tilt of the container so that the fluid in the chamber remains at an angle relative to a bottom wall of the container;
e. measuring the remaining fluid in the chamber via measuring indicia that is arranged on a side wall of the container at an angle relative to the bottom wall and substantially equal to the angle of the fluid in the tilted container; and
f. one of pouring more fluid through the opening or setting the container down.

16. A method for measuring fluid in a container as defined in claim 15, wherein the container is one of a transparent and translucent container.
